(19) United States
(12) Patent Application Publication
(10) Pub. No.: US 2026/0032404 A1
(43) Pub. Date: Jan. 29, 2026

(54) HANDHELD GPS DEVICE TO DRAW OR MODIFY GEOFENCES

(71) Applicant: Textron Inc., Providence, RI (US)

(72) Inventors: Brian David Wanta, North Augusta, SC (US); Preston Sering Easley, Martinez, GA (US)

(73) Assignee: Textron Inc., Providence, RI (US)

(21) Appl. No.: 18/782,384

(22) Filed: Jul. 24, 2024

(51) Int. Cl. H04W 4/02

(52) U.S. Cl. CPC H04W 4/023

(57) ABSTRACT

A golf course geofence system includes a remote computing device. The remote computing device is configured to receive a request from a portable device to generate a geofence at a current location of the portable device on a golf course, acquire position data regarding a position of the portable device, and generate the geofence at the current location in response to the request and based on the position data. The request includes at least one of (a) a first request to generate a predefined shape geofence or (b) a second request to generate a freeform geofence.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Geofences may be established around areas of the golf course where the golf carts and other vehicles should not drive. These areas may include greens, tee boxes, buildings, water, woods, among others. When the golf cart or the other vehicles drive in the area defined by the keep-out geofence, the operation thereof may be limited.

### SUMMARY

One embodiment relates to a golf course geofence system. The golf course geofence system includes a remote computing device. The remote computing device is configured to receive a request from a portable device to generate a geofence at a current location of the portable device on a golf course, acquire position data regarding a position of the portable device, and generate the geofence at the current location in response to the request and based on the position data. The request includes at least one of (a) a first request to generate a predefined shape geofence or (b) a second request to generate a freeform geofence.

Another embodiment relates to a geofence system. The geofence system includes one or more processing circuits including one or more memory devices and one or more processors. The one or more memory devices are configured to store instructions thereon that, when executed by the one or more processors, cause the one or more processors to receive a request from a user of a portable device to generate a geofence at a current location of the portable device, acquire position data regarding a position of the portable device, and generate the geofence at the current location in response to the request and based on the position data. The request includes at least one of (a) a first request to generate a predefined shape geofence or (b) a second request to generate a freeform geofence.

Still another embodiment relates to a method. The method includes receiving, by one or more processing circuits, a request from a user of a portable device to generate a geofence at a current location of the portable device; acquiring, by the one or more processing circuits, position data regarding a position of the portable device; generating, by the one or more processing circuits, the geofence at the current location in response to the request and based on the position data; monitoring, by the one or more processing circuits, a vehicle location of a vehicle relative to the geofence; and transmitting, by the one or more processing circuits, a signal to the vehicle in response the vehicle location indicating that the vehicle has entered, has exited, or is approaching the geofence, the signal configured cause the vehicle to adjust operation thereof or provide a warning to an operator thereof.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a perspective view of a handheld device, according to an exemplary embodiment.

FIG. 5 is a block diagram of a controller of the handheld device of FIG. 4, according to an exemplary embodiment.

FIG. 6 is an overhead view of a golf course having various geofences, according to an exemplary embodiment.

FIGS. 7-10 are various overhead views of a golf course as a user creates a freeform geofence, according to an exemplary embodiment.

FIG. 11 is a flowchart of a method for creating a geofence in a preset shape, according to an exemplary embodiment.

FIG. 12 is a flowchart of a method for creating a freeform geofence, according to an exemplary embodiment.

FIG. 13 is a flowchart of a method for editing geofences, according to an exemplary embodiment.

FIG. 14 is a flowchart of a method for reporting hazards and creating geofences around the hazards, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

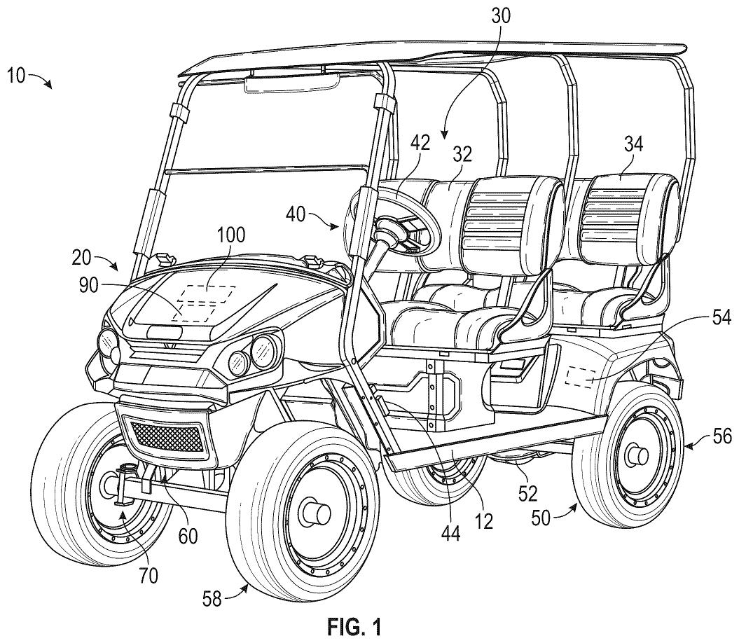

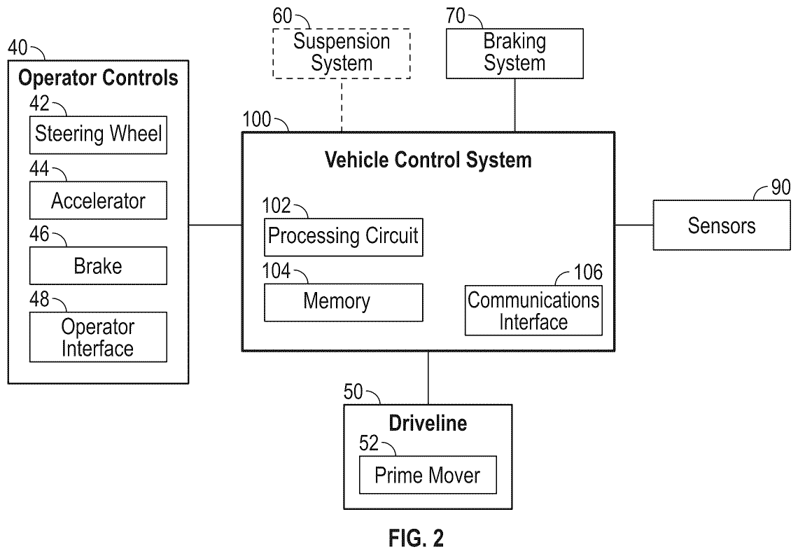

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks. The rear tractive assembly 56 and the front tractive assembly 58 may be configured to engage a ground surface to support the vehicle 10.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

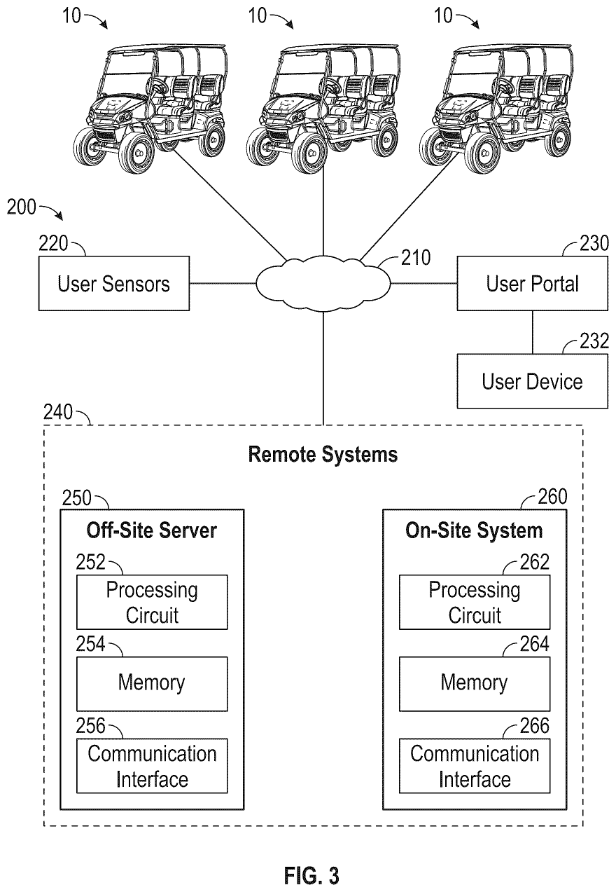

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10 and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Handheld GPS Device for Geofence Drawing

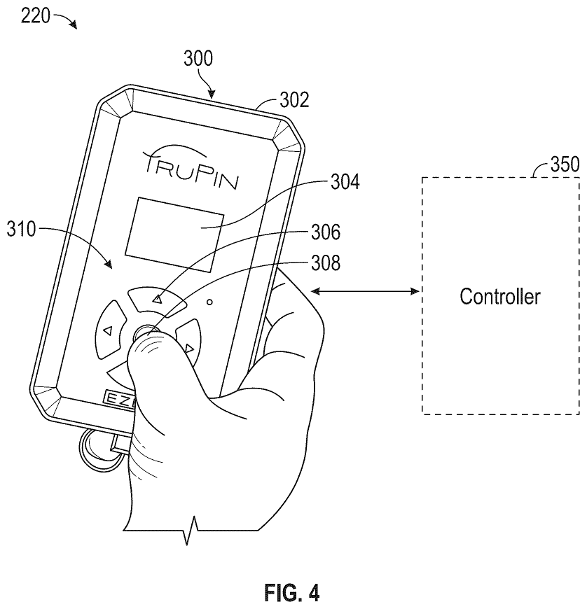

Referring to FIG. 4, a perspective view of a handheld device, shown as handheld GPS device 300, is shown according to an exemplary embodiment. The handheld GPS device 300 may function as a user sensor 220. In some embodiments, the handheld GPS device 300 is a TruPin device manufactured by E-Z-GO®. In some embodiments, the handheld GPS device 300 is another type of portable device (e.g., a smartphone, a smartwatch, a laptop, a tablet, etc.).

As shown in FIG. 4, the handheld GPS device 300 includes a housing 302, a display 304, a user interface 310, and a controller 350. The user interface 310 includes a plurality of buttons including navigational buttons 306 and selection button 308. The navigational buttons 306 may be used to toggle up, down, left, and right on the display 304. The selection button 308 may be used to make a selection of an item displayed by the display 304. The buttons may be hard key buttons or switches, or any combination of touch sensitive buttons, hard key buttons, or switches. In some embodiments, the display 304 is a liquid crystal display (“LCD”) or another type of suitable display. In some embodiments, the display 304 extends further than what is shown in the exemplary figure (e.g., comprising the front ⅓^{rd}, ½, or ⅔^{rds} of the housing 302). In other embodiments, the handheld GPS device 300 comprises a touch screen display where the buttons are integrated touch sensitive or soft buttons. In some embodiments, the display 304 shows a plurality of user selectable options. For example, a user may operate the buttons of the user interface 310 to select a “create geofence” option or an “edit geofence” option on the display 304. Once a user makes a selection, the display 304 may show a second set of user selectable options. For example, the user may select a “create new geofence” option from a first set of user selectable options, and may then select between a “freeform geofence” option and a “preset shape geofence” option. As another example, a user may operate the buttons of the user interface 310 to select a “hazard reporting” option on the display 304. Once a user makes a selection, the display 304 may show a second set of user selectable options that include types of hazards. For example, the user may select from a preset list of hazard options (e.g., discased grass, standing water, fallen landscaping/trees, full trash, insect infestations, damaged turf, dry spots, fire, broken sprinkler, erosion, lightning damage, washed out bunker, empty drink coolers, damaged green cup, clogged storm drain, etc.). Additionally or alternatively, a user may be prompted to enter a narrative regarding the type of hazard. As used herein, “hazards” should be understood or interpreted to encompass any issue that a golfer or employee of a golf course may wish to report for further inspection, maintenance, replacement, repair, removal, avoidance, etc.

In some embodiments, the handheld GPS device 300 is configured to transmit position data to a remote computing system (e.g., the remote systems 240) via the controller 350. In this way, the handheld GPS device 300 may be used to establish new geofences (e.g., a virtual boundary, a virtual fence, etc.) around a property. For example, a user may carry the handheld GPS device 300 on a golf course and may operate the user interface 310 to select an option to create a new geofence on the display 304. Responsive to this selection, the handheld GPS device 300 may begin periodically transmitting position data to the remote systems 240. As the user walks with the handheld GPS device 300, the positional data points are saved by the remote systems 240. Once the user finishes walking along a path that they would like to establish as a new geofence, they may select an option to end the new geofence creation session. Responsive to this selection, the remote systems 240 may apply the positional data points to a map of the golf course and connect them to create a virtual boundary. In some embodiments, a user may select how they would like the geofence to function. For example, a “keep-out” boundary, a “keep-in boundary,” or a “warning” boundary. The function selected by the user may be applied to the new geofence by the remote systems 240. The remote systems 240 may then utilize the new geofence to alter operation of the vehicle 10 when the vehicle 10 approaches, enters, or exits the new geofence. The vehicle controller 100 may operationally control (e.g., stop, speed limit, provide a warning message via an onboard display, etc.) the vehicle 10 based on the boundaries imposed by the new geofence.

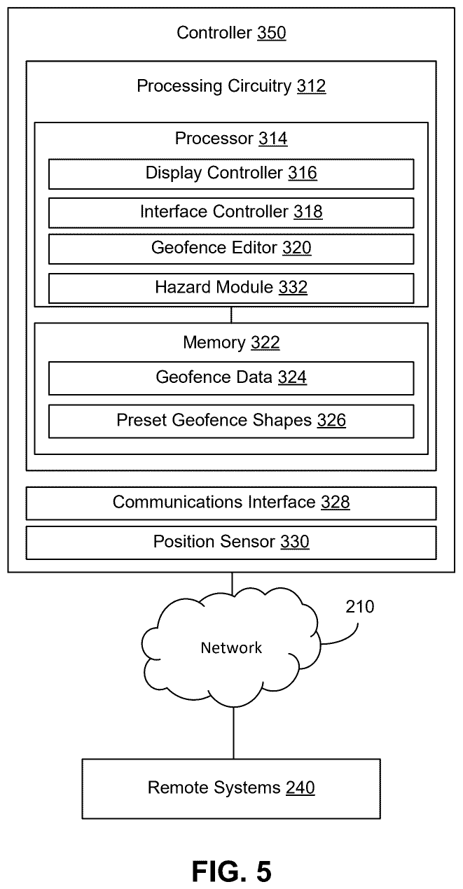

Referring to FIG. 5, a block diagram of the controller 350 of the handheld GPS device 300 is shown, according to an exemplary embodiment. As shown in FIG. 5, the controller 350 includes processing circuitry 312, a communications interface 328, and a position sensor 330. The processing circuitry 312 includes a processor 314 and a memory 322. The processor 314 may be a general purpose or specific purpose processor, an application specific integrated circuit (ASIC), one or more programmable logic controllers (PLCs), one or more field programmable gate arrays (FPGAs), a group of processing components, or other suitable processing components. Processor 314 is configured to execute computer code or instructions stored in the memory 322 or received from other computer readable media (e.g., embedded flash memory, local hard disk storage, local ROM, network storage, an off-site server, etc.).

The memory 322 may include one or more devices (e.g., memory units, memory devices, storage devices, etc.) for storing data and/or computer code for completing and/or facilitating the various processes described in the present disclosure. The memory 322 may include random access memory (RAM), read-only memory (ROM), hard drive storage, temporary storage, non-volatile memory, flash memory, optical memory, or any other suitable memory for storing software objects and/or computer instructions. The memory 322 may include database components, object code components, script components, or any other type of information structure for supporting the various activities and information structures described in the present disclosure. The memory 322 may be communicably connected to processor 314 and may include computer code for executing (e.g., by processor 314) one or more processes described herein. For example, the memory 322 may include graphics, web pages, HTML files, XML files, script code, shower configuration files, or other resources for use in generating graphical user interfaces for display and/or for use in interpreting user interface inputs to make command, control, or communication decisions.

The communications interface 328 may include wired or wireless communications interfaces (e.g., jacks, antennas, transmitters, receivers, transceivers, wire terminals, etc.) for conducting electronic data communications with various systems or devices. For example, the communications interface 328 may be used to communicate with the communications network 210, the on-site system 260, and/or the off-site server 250. Communications via the communications interface 328 may be direct (e.g., local wired or wireless communications), or via communications network 210 (e.g., a LAN, WAN, the Internet, a cellular network, etc.). For example, the communications interface 328 may include an Ethernet card and port for sending and receiving data via an Ethernet-based communications link or network. In another exemplary embodiment, the communications interface 328 can include a Wi-Fi transceiver for communicating via a wireless communications network or Wi-Fi direct communications. In another exemplary embodiment, the communications interface 328 may include cellular or mobile phone communications transceivers, a power line communications interface, and/or any other type of wired or wireless communications hardware.

The position sensor 330 may be disposed within the controller 350 or on the vehicle 10. The position sensor 330 may be a real or virtual sensor. In some embodiments, the position sensor 330 transmits data indicative of the position of the handheld GPS device 300 to a remote system (e.g., the remote systems 240). In exemplary embodiments, the data indicative of the position of the handheld GPS device 300 includes latitudinal and longitudinal positional coordinates.

As shown in FIG. 5, the memory 322 is shown to include geofence data 324 and preset geofence shapes 326. The geofence data 324 may include previously stored geofence boundaries. The preset geofence shapes 326 may provide the processor 314 with options for the user to select from regarding shapes for geofences (e.g., circular, triangular, rectangular, trapezoidal, and any similar polygonal shape). For example, the preset geofence shapes 326 on the memory 322 may include a circle with one or more preset diameters (e.g., 4 feet, 6 feet 8 feet, 10 feet, 15 feet, 20 feet, etc.).

As shown in FIG. 5, the processor 312 includes a display controller 316, an interface controller 318, a geofence editor 320, and a hazard module 332. The display controller 316 is communicatively or physically coupled with the display 304. The display controller 316 may control the options displayed to the user. For example, the display controller 316 may operate the display 304 to show a menu of user selectable options. A user may navigate the displayed options using the user interface 310 and the corresponding buttons thereof (e.g., the navigational buttons 306, the selection button 308, etc.). The interface controller 318 is coupled with the user interface 310. The interface controller 318 may read the button pushes by a user on the user interface 310 and transmit a corresponding signal to the display controller 316. For example, if a user presses or taps on a right arrow navigational button 306, the interface controller 318 reads this input as a command to move right. The interface controller 318 may, in turn, transmit this command to the display controller 316 to move a displayed curser right or transition to a subsequent menu or page.

The geofence editor 320 is configured to enable a user to create new geofences and/or edit existing geofences, according to various exemplary embodiments. In some embodiments, the geofence editor 320 includes a geofence creation module. The geofence creation module may include or provide an option for a user to create a freeform geofence. In this example, a user may walk with the handheld GPS device 300 to define the boundaries of a new, freeform geofence. The geofence creation module may additionally or alternatively include or provide an option for a user to select a preset shape from a library of shapes (e.g., the preset geofence shapes 326 stored in the memory 322) to create a predefined shape geofence. For example, a user may stand with the handheld GPS device 300 at the center of a desired geofence area and may select a circle option from the library. The user may be prompted to set a diameter, radius, or circumference of the circle to create the desired boundaries of a new, predefined shape geofence. In some embodiments, the preset geofence shapes 326 are stored in the remote systems 240 and the handheld GPS device 300 accesses the preset geofence shapes 326 via the remote systems 240 to facilitate the selection of a respective shape by the user.

In some embodiments, a user may edit or delete existing geofences using the geofence editor 320. For example, a user may be notified via the handheld GPS device 300 when the handheld GPS device 300 is approaching or has entered a previously set geofence that is stored in the geofence data 324. In some embodiments, the geofence data 324 is stored in the remote systems 240 and the remote systems 240 monitor the location of the handheld GPS device 300 and transmit a notification signal thereto when the handheld GPS device 300 is approaching or has entered the previously set geofence that is stored in the geofence data 324. A user may choose to edit or delete the geofence via the handheld GPS device 300 in response to the notification. In some embodiments, the display 304 shows the current boundaries of the geofence and may show where a user is in relation to the geofence. The user may edit the boundaries of the geofence by walking along a portion of the geofence and walking outside of the geofence to define new boundaries. In other embodiments, the existing geofence is a preset shape, such as a rectangle or a circle. In this example, a user may stand at a location they desire to move the center of the existing geofence to. Alternatively or additionally, a user may edit the dimensions of the preset shape. For example, a user may increase or decrease the diameter of an existing circular geofence.

The hazard module 332 is configured to enable a user to report hazards and/or create new geofences and/or edit existing geofences, according to various exemplary embodiments. The hazard module 322 may include or provide an option for a user to report a hazard they find in a space (e.g., a golf course). For example, the user may select from a list of preset hazard types (e.g., diseased grass, standing water, fallen landscaping/trees, full trash, insect infestations, etc.). The user may be prompted to enter a narrative regarding details of the hazard (e.g., size, location relative to landmarks, severity, etc.). In some embodiments, a user inputs their authorization level when reporting a hazard (e.g., golfer, staff, management, etc.). The type of hazard selected may be transmitted to the remote systems 240), which may, in turn, transmit a geofence creation signal to the handheld GPS device 300. In other embodiments a geofence creation signal is not sent, and instead, an authorized user (e.g., golf course staff member, course manager, etc.) may be prompted to confirm the presence of a non-employee reported hazard. For example, a golfer reports standing water at a golf course hole. The golfer inputs their authorization as a non-employee of the golf course (e.g., golfer, member, etc.). Responsive to receiving a signal that a hazard has been inputted by a non-employee, the remote systems 240 may prompt an employee to confirm the presence of the reported hazard. As another example, a groundskeeper may find and report a hazard, and responsive to receiving a signal that a hazard has been inputted by an employee, the remote systems 240 transmit a geo-fence creation signal to enable the employee to create a geofence around the hazard. In this way, hazard confirmation may only be required for non-authorized users. In some embodiments, the handheld GPS devices 300 may have pre-programmed authorization. For example, a golf course may have a small number of pre-programmed “employee” devices that are authorized to create geofences automatically.

In some embodiments, the user of the handheld GPS device 300 may be prompted to create a geofence depending on the type of hazard reported. In this example, the remote systems 240 may transmit a geofence creation signal when the type of hazard reported indicates that a portion of a physical location (e.g., the golf course) is obstructed or damaged by the hazard. Contrarily, the remote systems 240 may refrain from transmitting a geofence creation signal when the type of hazard does not generally obstruct or cause damage to a portion of the physical location. For example, a golfer may find and report a fallen tree on the fairway. In this example, a user may be prompted to create a new freeform geofence. In this example, the user may walk with the handheld GPS device 300 to define the boundaries of a new, freeform geofence. Alternatively, the remote systems 240 may notify a separate user (e.g., course staff or management) to confirm the presence of the reported hazard prior to transmitting a geofence creation signal (which would be transmitted to a separate, golf course associated device of the separate user confirming the hazard). As another example, a golfer may report that a trash can is full. In this example, the remote systems 240 may refrain from transmitting a geo-fence creation signal to the handheld GPS device 300.

In some embodiments, an authorized user can remove a hazard geofence when the hazard has been addressed. In some embodiments, the remote systems 240 are configured to provide a map of the golf course displaying that location of all active hazards including confirmed hazards and unconfirmed hazards, and the locations thereof. Such map may be accessed by grounds keeping personnel to address as they have availability. In some embodiments, the active hazards may be prioritized by the remote systems based on significance or severity. Various different types of indications may be provided on the map to indicate significance or severity (e.g., color, flashing, size, etc.). In some embodiments, a hazard geofence is set up to be static and only changes or is removed in response to a user editing or deleting the hazard geofence. In some embodiments, a hazard geofence is set up to be dynamic such that is changes with respect to time. By way of example, the hazard geofence may be set up to expire after a period of time.

The communications interface 328 may transmit the new geofences, edits to existing geofences, and/or deletions of existing geofences to the remote systems 240 through the communications network 210. In this way, a user may edit or view the new geofences or geofence edits on a remote display, such as a web page. In other embodiments, the communications interface 328 is configured to directly transmit the geofences and/or geofence edits to the off-site server 250 and/or the on-site system 260. In some embodiments, the geofences and/or the geofence edits are transferred directly to the vehicle controller 100.

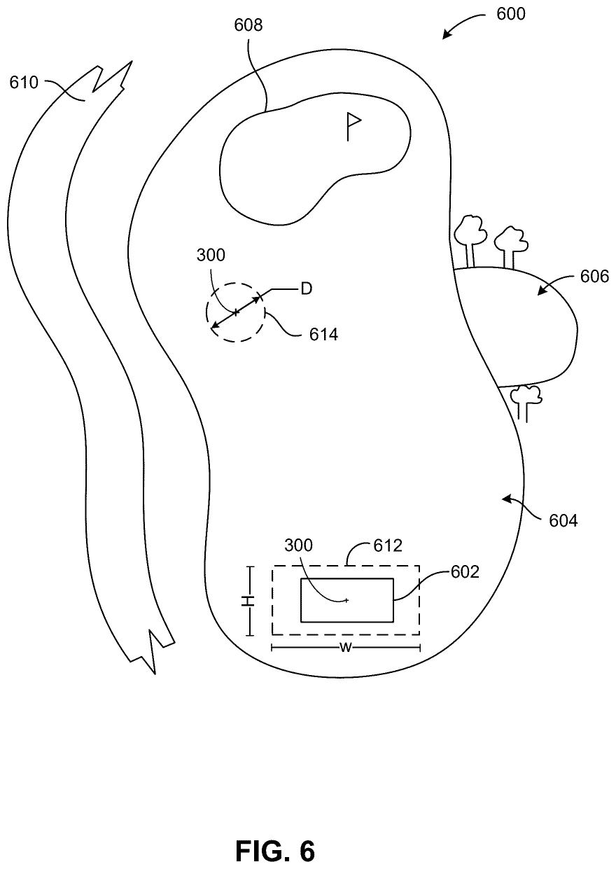

Referring to FIG. 6, an overhead view of a golf course 600 having various geofences is shown, according to an exemplary embodiment. In this example, a user may create geofences by selecting a desired shape. For example, a user may establish a circular “keep out” geofence 614 around a hazard 616 (e.g., a wet or flooded portion of the fairway, a fallen tree, a sink hole, a dead grass arca, etc.). In this example, the user may approach the hazard 616 and select a create geofence option on the handheld GPS device 300. The user is prompted to choose between a preset shape (e.g., a square, rectangle, circle, triangle, etc.) or a freeform geofence creation option. If the user selects the preset shape option and a circle to set the geofence shape, and then adjusts or sets the diameter D of the circle to create the geofence 614. In a similar example, a user may create a “keep out” boundary 612 around the tee box 602 by selecting a rectangle preset shape option on the handheld GPS device 300. The user may set a base width W and height H value to establish the boundaries of the rectangular geofence 612 around the tee box 602. In some embodiments, a user may select a preset ellipse shape to create a “keep out” geofence around the green 608. In other embodiments, a user may select the freeform geofence creation option and may establish the geofence around the green 608 by walking the green's perimeter. In this way, a user may tailor the shape of the geofence around the green to various oblong shapes, such that the geofence extends equally from all sides of the green 608.

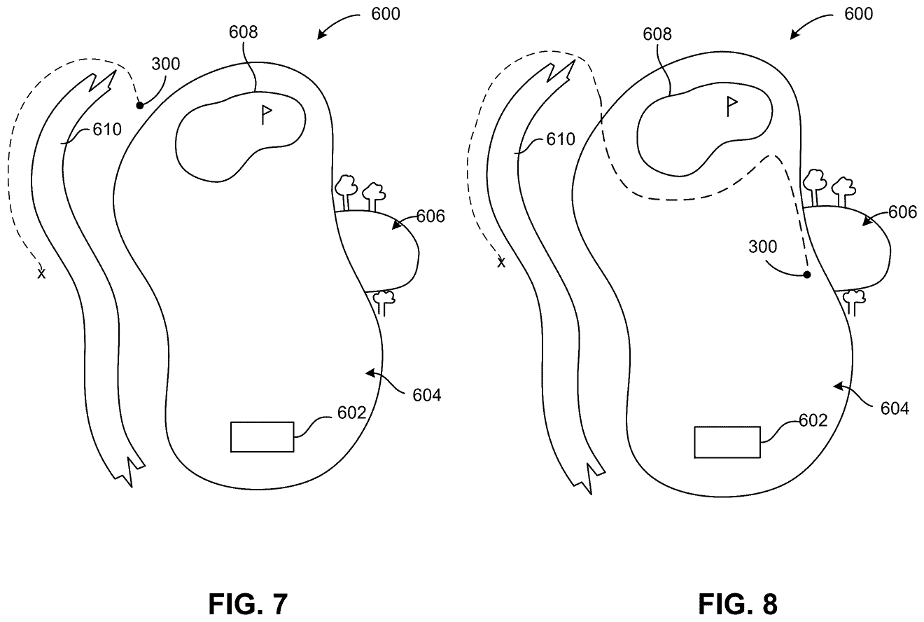

Referring now to FIGS. 7-10, progressive overhead views of the golf course 600 is shown as a user creates a freeform geofence, according to an exemplary embodiment. FIGS. 7-10 show a progression of a user as they walk with the handheld GPS device 300 around the golf course 600 to define the boundaries of a freeform geofence. As shown in FIG. 7, the user may begin by selecting a freeform geofence creation option on the display 304 of the handheld GPS device 300 (e.g., at the origin location designated by the “X”). Once such option is selected, a user may be prompted to begin moving with the handheld GPS device 300 (e.g., via a notification on the display 304, using a sound, vibrations, etc.). As the user progresses along their desired geofence path, the handheld GPS device 300 periodically transmits positional data to the remote systems 240 (e.g., every second, every 2 seconds, every 5 seconds, every 10 seconds, etc.). The remote systems 240 may then record each positional data point transmitted to map out the boundaries of the freeform geofence.

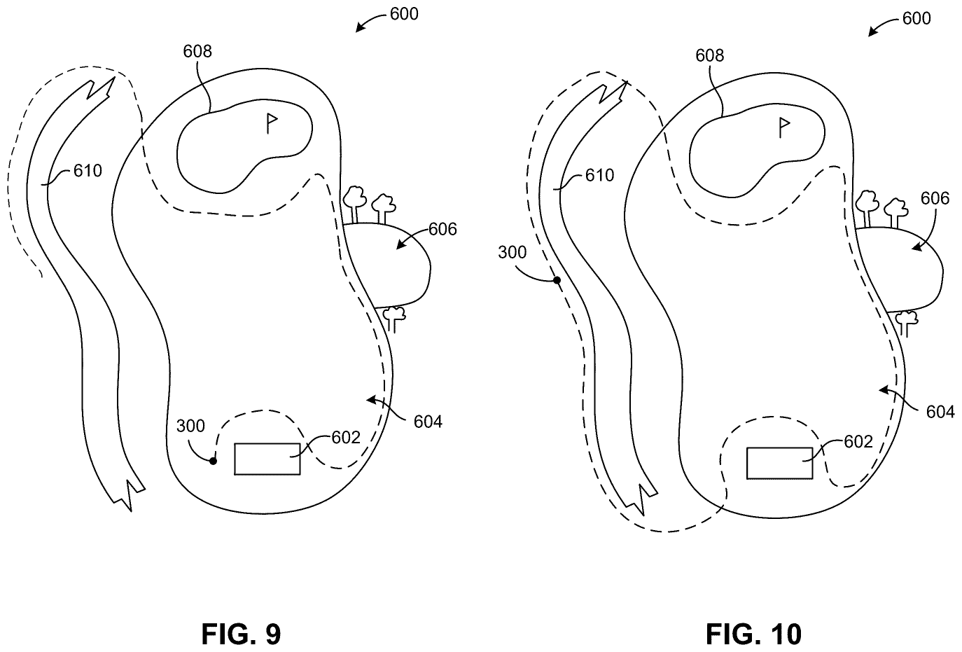

As shown in FIG. 8, the user may walk to avoid areas that vehicles 10 should not drive on. For example, the user defines a boundary line below the green 608 and a boundary line along an out-of-bounds or off-course arca 606 (e.g., wooded areas, water, tall grass, etc.). As shown in FIG. 9, the user may define a boundary around the tee box 602 that allows vehicles 10 to park on a side of the tee box 602, but not inside of the tee box 602. As shown in FIG. 10, the user proceeds to the origin point X of the freeform path to end the geofence creation process. It should be understood that any shape and size of the freeform geofence may be created by the user to generate a boundary or geofence around any desired area of the golf course 600 (e.g., the around the tee box 602, around the green 608, around a hazard 616, etc.).

In some embodiments, the user is notified that they are approaching the origin point X and are given an option to end the geofence creation session. Alternatively, the handheld GPS device 300 may automatically end the geofence creation session when the user approaches the origin point (e.g., comes within 1 foot, 5 feet, etc.). In other embodiments, the user can manually end the geofence creation session. The handheld GPS device 300 may notify the user when the session is complete (e.g., via a sound, vibration, or on screen notification). In some embodiments, a user may end the geofence creation session before they are on or near the origin point X of the freeform path. In this example, the remote systems 240 may be configured to connect the last transmitted position point with the origin point of the freeform geofence to create a complete boundary. In other embodiments, the boundaries may be left with open portions (e.g., in a U shape).

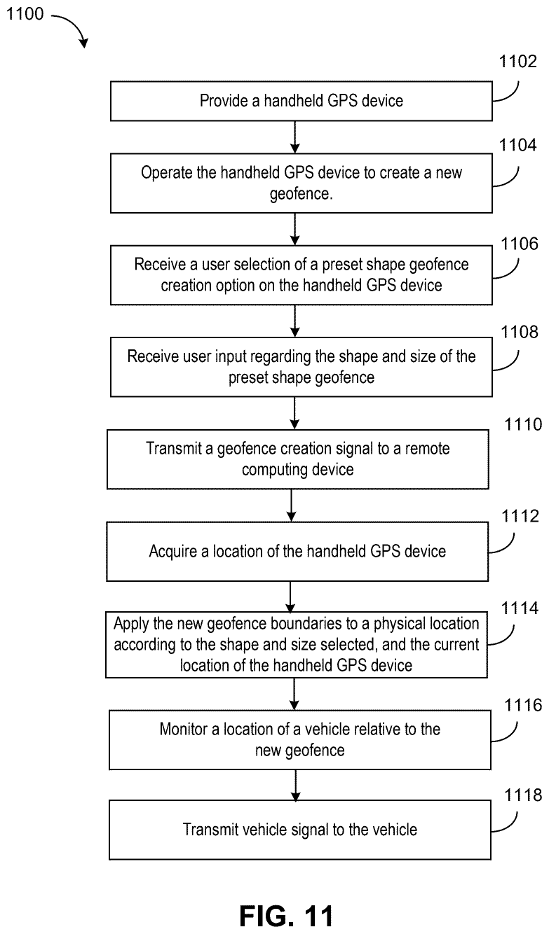

Referring now to FIG. 11, a flowchart of a method 1100 for creating a geofence in a preset shape is shown, according to an exemplary embodiment. The method 1100 may be performed by a local device (e.g., the handheld GPS device 300) and a remote computing device (e.g., the remote systems 240). The method 1100 may include providing a user with a handheld GPS device (e.g., the handheld GPS device 300, a user sensor 220, etc.) (step 1102). At step 1104, the user may operate the handheld GPS device to create a new geofence by selecting from a menu of options displayed on a display (e.g., the display 304) of the handheld GPS device. At step 1106, the handheld GPS device is configured to receive a user selection of an option to create the new geofence using a present shape (e.g., square, rectangle, circle, etc.). At step 1108, the handheld GPS device is configured to receive a user input including a selection of a preset shape and a size or desired dimensions of the preset shape for the new geofence. For example, a user may select a shape from a library of preset shapes and enter values regarding the size of the new geofence (e.g., diameter, length, width, etc.).

At step 1110, once the user inputs the parameters of the new geofence (e.g., shape, size, etc.), the handheld GPS device is configured to transmit and the remote computing device is configured to receive a geofence creation signal accordingly. The geofence creation signal may include the various user inputs and selections including the request to generate a new geofence, the selection of a preset shape, and the dimensions for the preset shape.

A step 1112, the remote computing device is configured to acquire a current location of the handheld GPS device. At step 1114, the remote computing device is configured to apply the newly inputted geofence boundaries to a physical location (e.g., a golf course) according to the shape and size selected by the user, and the current location of the handheld GPS device. In some embodiments, the remote computing device is configured to superimpose the shape onto a map of the physical location to scale of the size selected by the user using satellite imagery. In other embodiments, the off-site server may calculate points of latitude and longitude for the shape to apply the geofence to the physical location.

At step 1116, the remote computing device is configured to monitor a location of a vehicle (e.g., the vehicle 10) relative to the new geofence. At step 1118, the remote computing device is configured to transmit a vehicle signal to the vehicle in response to the vehicle approaching, entering, or exiting the new geofence. The vehicle signal may include a command that causes the vehicle to slow down, stop, provide a warning message to the operator of the vehicle, or permit a faster driving speed, among other possibilities. In this way, the vehicle may be stopped upon crossing or approaching a geofence boundary line.

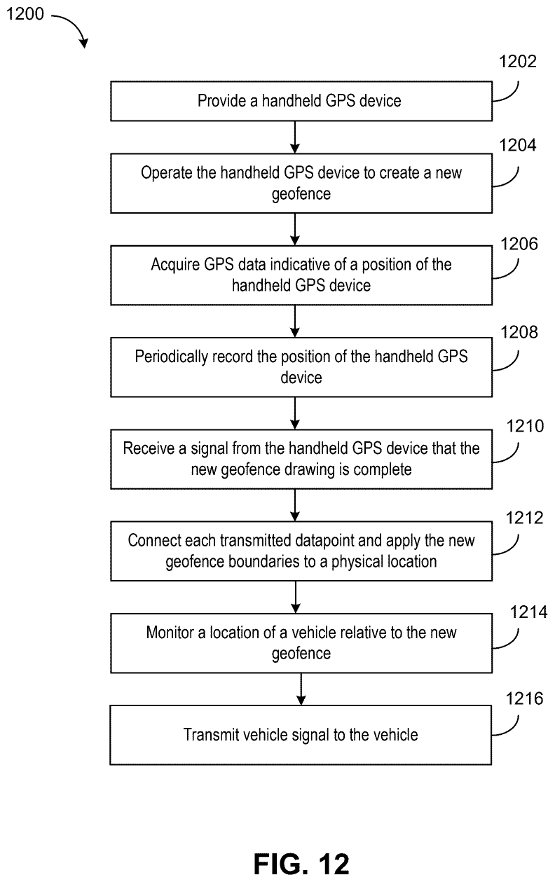

Referring to FIG. 12, a flowchart of a method 1200 for creating a freeform geofence, according to an exemplary embodiment. The method 1200 may be performed by a local device (e.g., the handheld GPS device 300) and a remote computing device (e.g., the remote systems 240). The method may include providing a user with a handheld GPS device (e.g., the handheld GPS device 300, a user sensor 220) (step 1202).

A user may operate the handheld GPS device to create a new geofence by selecting from a menu of options (step 1204). Once a user selects an option to create a new geofence, a remote computing device (e.g., the remote systems 240) may receive a signal accordingly. The remote computing device may receive a signal responsive to a user selecting an option to create a new freeform geofence. In some embodiments, the handheld GPS device notifies the user to begin moving with the handheld GPS device responsive to their selection to create the new freeform geofence.

As the user moves with the handheld GPS device, the positional data of the handheld GPS device is transmitted to or acquired by the remote computing device. The remote computing device acquires and stores the positional data indicative of the position of the handheld GPS device (steps 1206, 1208). The GPS device may record the position of the GPS device in periodic increments of time (e.g., every 1, 2, 3, 5, 10, 15, 20, 30, etc. seconds) or distance (e.g., every yard, 10 feet, 25 feet, 10 yards, etc.).

A user may input, on the handheld GPS device, that they have finished drawing the new geofence. At step 1210, the remote computing device is configured to receive the user's input that the new geofence drawing is complete. At step 1212, the remote computing device may connect each of the transmitted positional data to determine the boundaries of the new geofence. The remote computing device may apply the newly inputted geofence boundaries to a physical location (e.g., a golf course) according to the shape formed by connecting each transmitted data point. The remote computing device may superimpose the freeform boundary onto a map of the physical location using satellite imagery. In other embodiments, the remote computing device may calculate points of latitude and longitude for the shape to apply the geofence to the physical location.

At step 1214, the remote computing device is configured to monitor a location of a vehicle (e.g., the vehicle 10) relative to the new geofence. At step 1216, the remote computing device is configured to transmit a vehicle signal to the vehicle in response to the vehicle approaching, entering, or exiting the new geofence. The vehicle signal may include a command that causes the vehicle to slow down, stop, provide a warning message to the operator of the vehicle, or permit a faster driving speed, among other possibilities. In this way, the vehicle may be stopped upon crossing or approaching a geofence boundary line.

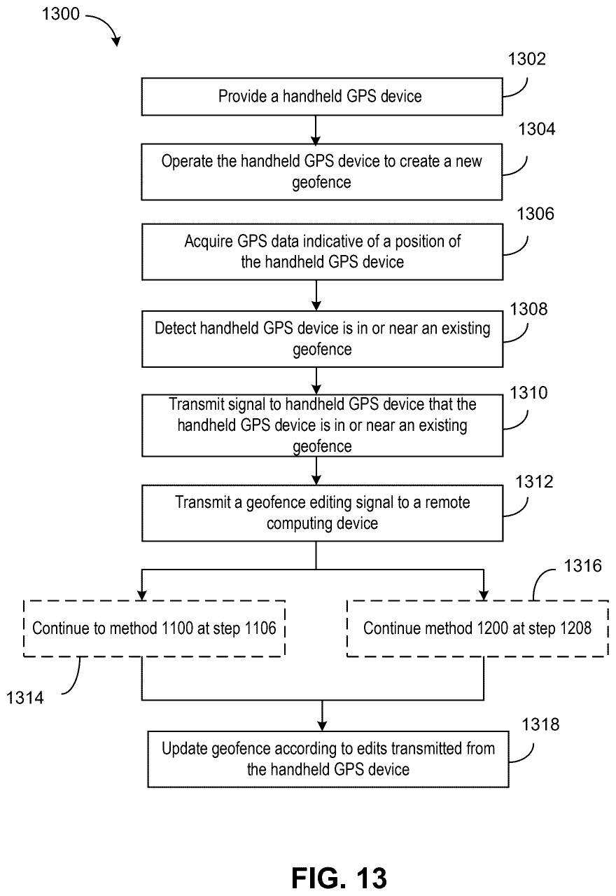

Referring to FIG. 13, a flowchart of a method 1300 for editing geofences, according to an exemplary embodiment. The method 1300 may be performed by a local device (e.g., the handheld GPS device 300) and a remote computing device (e.g., the remote systems 240). In an exemplary embodiment, the remote computing device includes a data store that stores all active geo-fences for a location (e.g., a golf course). Like the methods described in FIGS. 11 and 12, a user is provided with a handheld GPS device (e.g., handheld GPS device 300, user sensors 220) (step 1302) and the handheld GPS device is operated to create new geofences (step 1304; see FIGS. 11 and 12).

At step 1306, the remote computing device acquires GPS data indicative of a position of the handheld GPS device periodically. At step 1308, the remote computing device, utilizing its data store of existing geofence, detects that the handheld GPS device is in or near an existing geofence. Responsive to the handheld GPS device entering a geofence boundary or coming within a predefined distance of an existing geofence, the remote computing device may transmit a corresponding signal to the handheld GPS device (step 1310). Responsive to receiving a transmission indicating the handheld GPS device's proximity with a pre-existing geo-fence, the handheld GPS device may notify the user that they may edit an existing geofence. If a user selects an option to edit the existing geofence, the handheld GPS device transmits a signal to the remote computing device indicating that the user is editing the pre-existing geofence (step 1312).

A user may edit the geofence according to steps 1106 and 1108 of FIG. 11 (step 1314) or according to steps 1206-1210 of FIG. 12 (step 1316). For example, the user may edit the shape and dimensions of an existing preset shape geofence. In another example, the user may edit a freeform geofence by walking to establish a new boundary line. In some embodiments, a user may edit the existing geofence by changing it from a freeform geofence to a preset shape or from a preset shape to a freeform geofence. Consistent with steps 1110 and 1210, the remote computing device may receive a signal from the handheld GPS device indicating that user is done editing the pre-existing geofence. Responsive to this indication, the remote computing device may update the pre-existing geofence data points according to the edited values transmitted from the handheld GPS device (step 1318). Consistent with steps 1116 and 1118, as well as steps 1214 and 1216, the remote computing device is configured to transmit a vehicle signal to the vehicle in response to the vehicle approaching, entering, or exiting the edited geofence. The vehicle signal may include a command that causes the vehicle to slow down, stop, provide a warning message to the operator of the vehicle, or permit a faster driving speed, among other possibilities. In this way, the vehicle may be stopped upon crossing or approaching a geofence boundary line.

In some embodiments, a user may view a map of pre-existing geofences on the display 304 of the handheld GPS device 300. In this example, a user may select the geofence they would like to edit using the user interface 310 and its associated buttons 306 and 308.

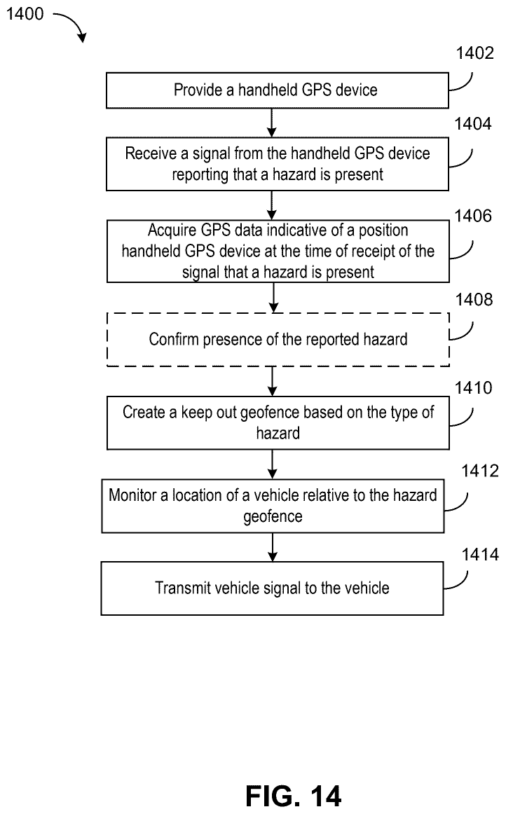

Referring to FIG. 14, a flowchart of a method for reporting hazards and creating geofences around hazards, according to an exemplary embodiment. For example, a user (e.g., a golf player, a groundskeeper, etc.) may carry a handheld GPS device (e.g., the handheld GPS device 300) on a golf course and may operate the handheld device to report a hazard (e.g., diseased grass, standing water, fallen landscaping/trees, full trash, insect infestations, etc.) (steps 1402 and 1404). The handheld GPS device transmits a signal reporting the hazard to a remote computing device (e.g., the remote systems 240), which may, in turn acquire GPS data indicative of a position of the handheld GPS device at the time the hazard is reported (step 1406). At step 1408 a supervising user may optionally confirm the presence of the reported hazard. For example, a golf player may indicate standing water on a portion of a golf course using the handheld GPS device (e.g., provided by golf course management, their own personal device, etc.). The remote computing device may provide or display a notification of the reported hazard on a user display accessible by golf course management (e.g., a web browser, a supervisor device, etc.). Golf course management may manually confirm the presence of the reported hazard before creating a geofence. In another example, a member of golf course staff/management may indicate standing water on a portion of a golf course using a handheld GPS device and may be prompted to create a new “keep out” geofence without secondary confirmation of the presence of the reported hazard.

Responsive to receiving and optionally confirming a report of a hazard, a user may use the remote computing device or another handheld GPS device to create a new “keep out” geofence based on the type of hazard reported (step 1410). For example, if the hazard is a relatively small amount of standing water, a circular geofence with a 5-foot diameter may be created around the boundaries of the hazard. In another example, if a hazard is a fallen tree on the golf course or the cart paths, a freeform geofence may be made by walking around the fallen tree. Alternatively, a large rectangular geofence may be implemented in the area (e.g., 50 ft by 100 ft). At steps 1412 and 1414, once the hazard related geofence is set by the remote computing device, the remote computing device is configured to monitor a location of a vehicle (e.g., the vehicle 10) relative to the hazard geofence and transmit a vehicle signal to the vehicle in response to the vehicle approaching or entering the hazard geofence. In this way, the vehicle is prevented from entering an area with a hazard present. In addition, in response to confirmation of the reported hazard, appropriate personnel on the golf course may be notified of the respective hazard to take corrective action (e.g., empty the trash, address the insect infestation, remove a fallen tree, etc.).

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and descriptions may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.), the site monitoring and control system 200 (e.g., the remote systems 240, the user portal 230, the user sensors 220, etc.), and the handheld GPS device 300 as shown in the various exemplary embodiments is illustrative only. Additionally, any element disclosed in one embodiment may be incorporated or utilized with any other embodiment disclosed herein.

1. A golf course geofence system comprising:
a remote computing device configured to:
receive a request from a portable device to generate a geofence at a current location of the portable device on a golf course, the request including at least one of (a) a first request to generate a predefined shape geofence or (b) a second request to generate a freeform geofence;
acquire position data regarding a position of the portable device; and
generate the geofence at the current location in response to the request and based on the position data.

2. The golf course geofence system of claim 1, further comprising the portable device, wherein the portable device is configured to prompt a user to edit or delete an existing geofence based on the location of the portable device.

3. The golf course geofence system of claim 1, wherein the request includes a function of the geofence, wherein the function includes at least one of a keep-out boundary, a keep-in boundary, or a warning boundary.

4. The golf course geofence system of claim 1, wherein the remote computing device is configured to:
monitor a vehicle location of a vehicle relative to the geofence; and
transmit a signal to the vehicle in response the vehicle location indicating that the vehicle has entered, has exited, or is approaching the geofence, the signal configured cause the vehicle to adjust operation thereof or provide a warning to an operator thereof.

5. The golf course geofence system of claim 1, wherein the remote computing device is configured to:
overlay the geofence onto a map of the golf course; and
apply the geofence to a physical location on the golf course corresponding with the map.

6. The golf course geofence system of claim 1, further comprising the portable device, wherein the portable device includes:
a position sensor;
a user interface including a display;
a communications interface configured to facilitate wireless communications with the remote computing device; and
a controller configured to:
cause the display to display a menu of user selectable options;
receive a selection from the user interface to create the geofence; and
transmit the request to the remote computing device in response to the selection.

7. The golf course geofence system of claim 6, wherein the menu of user selectable options includes an option to generate the predefined shape geofence.

8. The golf course geofence system of claim 7, wherein, in response to a first selection of the option to generate the predefined shape geofence, the controller is configured to:
cause the display to display a library of preset shapes in response to the first selection;
receive a second selection of a respective preset shape from the library of preset shapes via the user interface;
receive an input via the user interface regarding one or more dimensions of the respective preset shape; and
transmit the respective preset shape and the one or more dimensions to the remote computing device.

9. The golf course geofence system of claim 6, wherein the menu of user selectable options includes an option to generate the freeform geofence.

10. The golf course geofence system of claim 9, wherein, in response to the selection of the option to generate the freeform geofence, the controller is configured to cause the remote computing device to track movements of the portable device between an initial location and a final location to facilitate generation of the freeform geofence.

11. The golf course geofence system of claim 1, wherein the remote computing device is configured to:
receive the first request to generate the predefined shape geofence, the first request including a selection of a respective preset shape from a plurality of preset shapes and one or more dimensions for the respective preset shape from the portable device; and
generate the geofence based on the respective preset shape, the one or more dimensions, and the current location of the portable device.

12. The golf course geofence system of claim 1, wherein the remote computing device is configured to:
receive the second request to generate the freeform geofence;
track movement of the portable device based on the position data from an initial location of the portable device to a final location of the portable device; and
generate the freeform geofence based on the movement between the initial location and the final location.

13. The golf course geofence system of claim 12, wherein the remote computing device is configured to connect the initial location and the final location to form the freeform geofence if the initial location and the final location do not coincide.

14. The golf course geofence system of claim 1, wherein the remote computing device is configured to:
determine that the portable device is in or near a pre-existing geofence based on the position data;
cause the portable device to provide a notification regarding an ability to edit or delete the pre-existing geofence in response to the portable device being in or near the pre-existing geofence;
receive a signal from the portable device in response to the notification, the signal including one or more inputs to modify or delete the pre-existing geofence;
modify or delete the pre-existing geofence based on the signal.

15. A geofence system comprising:
one or more processing circuits including one or more memory devices and one or more processors, the one or more memory devices configured to store instructions thereon that, when executed by the one or more processors, cause the one or more processors to:
receive a request from a user of a portable device to generate a geofence at a current location of the portable device, the request including at least one of (a) a first request to generate a predefined shape geofence or (b) a second request to generate a freeform geofence;
acquire position data regarding a position of the portable device; and
generate the geofence at the current location in response to the request and based on the position data.

16. The geofence system of claim 15, wherein the one or more processing circuits include at least one of (a) a first processing circuit for the portable device or (b) a second processing circuit remote from the portable device.

17. The geofence system of claim 15, wherein the instructions cause the one or more processors to:
receive the first request to generate the predefined shape geofence, the first request including a selection of a respective preset shape from a plurality of preset shapes and one or more dimensions for the respective preset shape from the portable device; and
generate the geofence based on the respective preset shape, the one or more dimensions, and the current location of the portable device.

18. The geofence system of claim 15, wherein the instructions cause the one or more processors to:
receive the second request to generate the freeform geofence;
track movement of the portable device based on the position data from an initial location of the portable device to a final location of the portable device; and
generate the freeform geofence based on the movement between the initial location and the final location.

19. A method comprising:
receiving, by one or more processing circuits, a request from a user of a portable device to generate a geofence at a current location of the portable device;
acquiring, by the one or more processing circuits, position data regarding a position of the portable device;
generating, by the one or more processing circuits, the geofence at the current location in response to the request and based on the position data;
monitoring, by the one or more processing circuits, a vehicle location of a vehicle relative to the geofence; and
transmitting, by the one or more processing circuits, a signal to the vehicle in response the vehicle location indicating that the vehicle has entered, has exited, or is approaching the geofence, the signal configured cause the vehicle to adjust operation thereof or provide a warning to an operator thereof.

20. The method of claim 19, wherein acquiring the position data and generating the geofence includes tracking movements of the portable device between an initial location and a final location to facilitate generation of a freeform geofence based on a path of the portable device between the initial location and the final location.
